(19) United States
(12) Patent Application Publication
(10) Pub. No.: US 2011/0131451 A1
(43) Pub. Date: Jun. 2, 2011

(54) METHODS AND SYSTEM FOR TESTING AN ENTERPRISE SYSTEM

(76) Inventor: Ricardo Bosch, Brooklyn, NY (US)

(21) Appl. No.: 12/627,064

(22) Filed: Nov. 30, 2009

(51) Int. Cl. G06F 11/36

(52) U.S. Cl. 714/33; 714/32; 714/E11.217

(57) ABSTRACT

A computer storage medium having a computer-readable code segment for performing a method may be provided. The method may include receiving inputs from a user using an interface, the inputs define a test that is run against the application software; associating a resource with the test, the resource selected by the user using the interface; executing the test against the application software; comparing an outputted value of the application software with an expected value; and outputting a result.

### BACKGROUND OF THE INVENTION

Enterprise system testing is a critical aspect in the development of a complex enterprise system. Generally, in some known testing embodiments, the enterprise system has multiple environments, such as for example, a development environment, a quality assurance environment and a production environment. Testing of the enterprise system ensures that any developmental and/or configuration changes made to the enterprise system, by parties related to the development of the system, do not cause other issues and such issues are not promoted to subsequent environments.

One known method of testing is performed using a JUnit test, which is part of open source libraries that are typically used to trigger individual methods in the software with particular values. JUnit testing may be time consuming because a programmer is required to code each test in a separate class and come up with a value for each test.

Moreover, many enterprise systems have numerous processes running therein. Testing each process individually may result in a tester modifying and changing that process to fix any problems the process may have. Those changes however, may adversely affect the other processes causing the tester to test all the other processes individually. As a result, the time required to test an enterprise system would be greatly increased using such known testing methods.

### BRIEF DESCRIPTION OF THE INVENTION

In one exemplary embodiment, a computer storage medium having a computer-readable code segment for performing a method may be provided. The method may include receiving inputs from a user using an interface, the inputs define a test that is run against the enterprise system; associating a resource with the test, the resource selected by the user using the interface; executing the test against the application software; comparing an outputted value of the application software with an expected value; and outputting a result.

In another exemplary embodiment, a system for testing application software may be provided. The system may include a processor; a testing framework executed by the processor; an application software coupled to the testing framework; a test builder coupled to the testing framework, the test builder receives inputs from a user to build a test; a resource coupled to the testing framework and associated with the test; and a message object coupled to the testing framework and executed by the processor to generate and send messages to the application software.

### BRIEF DESCRIPTION OF THE DRAWINGS

Advantages of embodiments of the present invention will be apparent from the following detailed description of the exemplary embodiments. The following detailed description should be considered in conjunction with the accompanying figures in which:

FIG. 1 is a schematic illustration of a testing system;

FIG. 2 is an enlarged schematic illustration of the testing system shown in FIG. 1;

FIG. 3 is an illustration of an exemplary trading enterprise system that may be used with the testing system shown in FIG. 1;

FIG. 4a is an illustration of a multiple environments of the exemplary trading enterprise system shown in FIG. 3;

FIG. 4b is an exemplary diagram of the Interface from test data to the testing framework;

FIG. 5 is a flowchart of a test that may be used by the testing system shown in FIG. 1;

FIG. 6 is an exemplary test sequence list that may be used with the testing system shown in FIG. 1;

FIG. 7 is a graphical user interface that may be used with the testing system shown in FIG. 1;

FIG. 8 is a list of exemplary resources that may be used with the testing system shown in FIG. 1;

FIG. 9a is an illustration of a resource window that may be used with the testing system shown in FIG. 1;

FIG. 9b is an illustration of an edit resource window that may be used with the testing system shown in FIG. 1;

FIG. 10 is an exemplary add test window that may be used with the testing system shown in FIG. 1;

FIG. 11 is an exemplary add test window that may be used with the testing system shown in FIG. 1;

FIG. 12 is an exemplary add test window that may be used with the testing system shown in FIG. 1;

FIG. 13 is an exemplary add test window that may be used with the testing system shown in FIG. 1; and

FIG. 14 is a flow diagram of a test sequence that may be used with the testing system shown in FIG. 1.

### DETAILED DESCRIPTION OF THE INVENTION

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many of the embodiments described herein are described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, “a computer configured to” perform the described action.

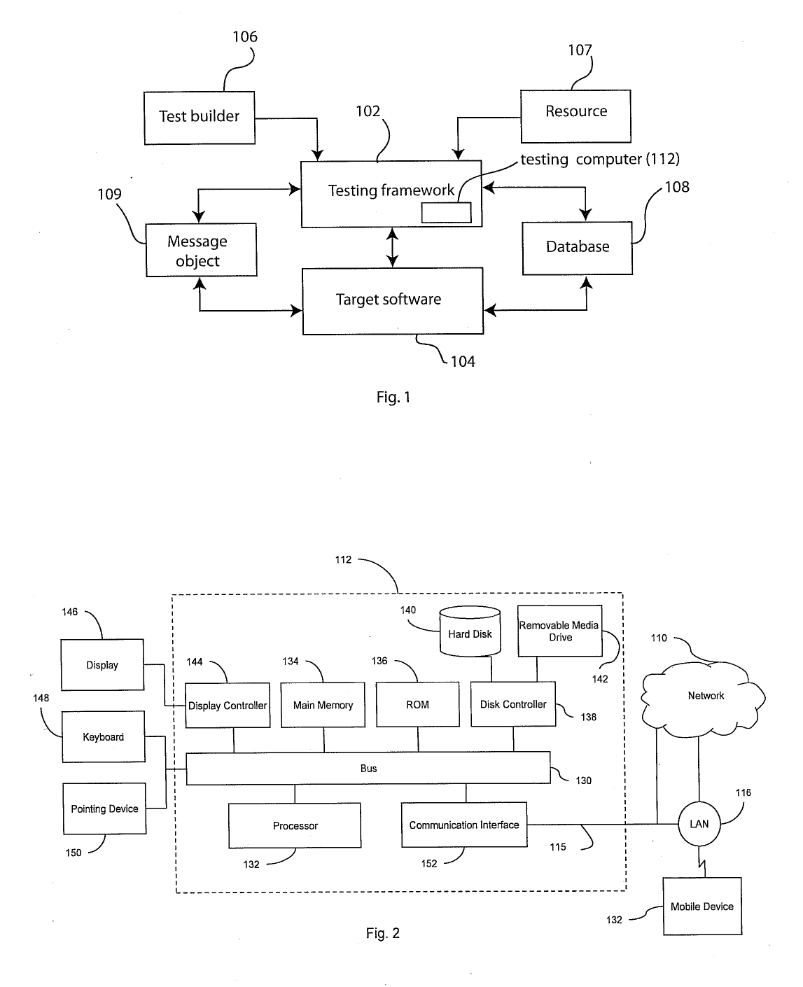

FIG. 1 is a schematic illustration of a testing system 100 for testing enterprise systems. FIG. 2 is an enlarged schematic illustration of testing system 100. In the exemplary embodiment, testing system 100 may include a testing framework 102 and an enterprise system 104, which may be tested by testing system 100. A non-limiting trading enterprise system example will be used to exemplify testing system 100, as described in more detail below. Testing system 100 may also include a test builder 106, a resource 107, a database 108 and a message object 109. In the exemplary embodiment, testing framework 102 may be coupled to the above-mentioned components using any connection means known to a person having ordinary skill in the art that enables testing system 100 to function as described herein. In one embodiment, enterprise system 104, test builder 106, resource 107, database 108 and message object 109 may be coupled in communication to one another and to testing framework 102 using a network 110. In the exemplary embodiment, network 110 may be the Internet. In an alternative embodiment, network 110 may be a local area network (LAN), a wireless LAN, a wide area network (WAN) and/or any other type of connection known to a person having ordinary skill in the art that enables testing system 100 to function as described, herein. Alternatively, all the above-mention components of testing system 100 may be housed within a computer.

Testing system 100 may also include a computer 112 coupled in communication to testing framework 102, enterprise system 104, test builder 106, resource 107, database 108 and message object 109 using a network connection 115 that is coupled to a local network 116 such as, but not limited to, a LAN, a wireless LAN, a WAN and/or any other connection that enables testing system 100 to function as described herein.

In the exemplary embodiment, test builder 106 may enable a user (not shown) to create tests (shown in FIGS. 10, 11, 12 and 13) on computer 112, which facilitate testing enterprise system 104. Alternatively, a plurality of computers 112 may be used, wherein each computer 112 may include a test programmed therein. As used herein, the term “test” may refer to a collection of logic and/or code that may be executed on computer 112 or any other type of device or processor that is capable of producing a response. In one embodiment, resource 107 may be a database, a communication layer, a protocol and/or a server. Database 108 may be any type of database known to a person having ordinary skill in the art that enables testing system 100 to function as described herein. Message object 109, may enable the user to generate specific “mock” messages to send to enterprise system 104, as described in more detail below.

In the exemplary embodiment, the term “computer” is not limited to just integrated circuits, but broadly refers to a processor, a microcontroller, a microcomputer, a programmable logic controller, an application specific integrated circuit and other programmable circuits. These aforementioned terms may be used interchangeably herein. In the exemplary embodiment, computer 112 may include a bus 130 or other communication mechanism for communicating information, and a processor 132 coupled with bus 130 for processing the information. In one embodiment, a plurality of processors 132 may be arranged in a multi-processor arrangement to facilitate faster processing as compared to a single processor arrangement. In the exemplary embodiment, testing system 100 may also include a main memory 134, such as a random access memory (RAM) or other dynamic storage device (e.g., dynamic RAM (DRAM), static RAM (SRAM) and synchronous DRAM (SDRAM)) coupled to bus 130 for storing information and instructions to be executed by processor 132. In addition, main memory 134 may be used for storing temporary variables or other intermediate information during the execution of instructions by processor 132. Testing system 100 may further include a read only memory (ROM) 136 or other static storage device (e.g., programmable ROM (PROM), erasable PROM (EPROM) and electrically erasable PROM (EEPROM)) coupled to bus 130 for storing static information and instructions for processor 132.

Testing system 100 may also include a disk controller 138 coupled to bus 130 to control one or more storage devices for storing information and instructions. In the exemplary embodiment, storage devices may include, but not limited to, a magnetic hard disk 140 and a removable media drive 142 (e.g., floppy disk drive, read-only compact disc drive, read/write compact disc drive, compact disc jukebox, tape drive and removable magneto-optical drive). The storage devices may be coupled to testing system 100 using any appropriate device interface known to one having ordinary skill in the art (e.g., small computer system interface (SCSI), integrated device electronics (IDE), enhanced-IDE (E-IDE), direct memory access (DMA), or ultra-DMA). Testing system 100 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

In the exemplary embodiment, main memory 134, hard disk 140 and removable media drive 142 are examples of computer-readable mediums that facilitate holding instructions programmed according to the teachings of the invention, data structures, tables, records and/or other data described herein. The term “computer-readable medium” or “computer-readable media” as used herein refers to any medium that facilitates storing and/or providing instructions to processor 132 for the execution thereof. The computer-readable media may include, but not limited to, non-volatile media, volatile media and transmission media. Non-volatile media may include, but not limited to, hard disks, floppy disks, tape, magneto-optical disks, PROMs (EPROM, EEPROM, flash EPROM), DRAM, SRAM, SDRAM or any other magnetic medium. Moreover, non-volatile media may also include compact discs (e.g., CD-ROM) or any other optical medium. Further, non-volatile media may include punch cards, paper tape or other physical medium with patterns of holes. Volatile media may include dynamic memory, such as main memory 134. Transmission media may include coaxial cables, copper wire and fiber optics, including the wires that make up bus 130. Transmission media may also include carrier waves such as acoustic or light waves that may be generated using radio waves and infrared data communications.

In the exemplary embodiment, the computer-readable media may include software that facilitates controlling testing system 100. Such software may include, but is not limited to, device drivers, operating systems, development tools and applications software. Such computer-readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

In the exemplary embodiment, testing system 100 may further include a display controller 144 coupled to bus 130 to control a display 146, such as a cathode ray tube (CRT), liquid crystal display (LCD) or any other type of display to facilitate displaying information to a computer user. Testing system 100 may include a plurality of input devices, such as a keyboard 148 and a pointing device 150, to facilitate interacting with the computer user and providing information to processor 132. Alternatively, a touch screen may be used in conjunction with display 146. In one embodiment, pointing device 150 may be a mouse, a trackball or a pointing stick for communicating direction information and command selections to processor 132 and for controlling cursor movement on display 146. In addition, a printer (not shown) may be coupled to testing system 100 to facilitate printing data stored and/or generated by testing system 100.

Testing system 100 also includes a communication interface 152 coupled to bus 130, wherein communication interface 152 may be coupled in communication to LAN 116 or network 110 using network connection 115. In one embodiment, communication interface 152 may be a network interface card that is coupled in communication to any packet switched LAN. In another embodiment, communication interface 152 may be an asymmetrical digital subscriber line (ADSL) card, an integrated services digital network (ISDN) card or a modem to facilitate providing a data communication connection to network connection 115. In yet another embodiment, wireless connections may be used to couple communication interface 152 to LAN 116 and/or network 110. In the exemplary embodiment, communication interface 152 sends and receives electrical, electromagnetic or optical signals that carry digital data to and from testing system 100, which are exemplary forms of carrier waves that facilitate transporting information. Testing system 100 may also transmit and receive data, including program code, through networks 116 and 110 using network connection 115 and communication interface 152. Moreover, network connection 115 may couple computer 112 in communication to a mobile device 132 such as a personal digital assistant (PDA), a laptop computer, a cellular telephone, a smart phone, an ultra-compact mobile device or any other mobile device that enables testing system 100 to function as described herein.

During operation, testing system 100 may perform a portion or all of the processing steps of the invention in response to processor 132 executing one or more sequences of one or more instructions contained within main memory 134 and/or other forms of computer-readable media. In one embodiment, processor 132 may execute the instructions contained within the computer-readable media. In another embodiment, hard-wired circuitry may be used in place of or in combination with the instructions. Thus, the exemplary embodiments described herein are not limited to any specific combination of hardware circuitry and software. For example, the instructions may initially be carried on a magnetic disk of a remote computer. The remote computer can load the instructions for implementing all or a portion of the present invention remotely into a dynamic memory and send the instructions over a telephone line using a modem. A modem local to testing system 100 may receive the data on the telephone line and use an infrared transmitter to convert the data to an infrared signal. An infrared detector coupled to bus 130 can receive the data carried in the infrared signal and place the data on bus 130. Bus 130 carries the data to main memory 134, from which processor 132 retrieves and executes the instructions. The instructions received by main memory 134 may optionally be stored on hard disk 140 or removable media drive 142 either before or after execution by processor 132.

Other aspects of the invention may include data transmission and Internet-related activities. See Gralla, Preston, How the Internet Works, Ziff-Davis Press (1996), which is hereby incorporated by reference into this patent application. Still other aspects of the invention may utilize wireless data transmission, such as those described in U.S. Pat. Nos. 6,456,645, 5,818,328 and/or 6,208,445, all of which are hereby incorporated by reference into this patent application.

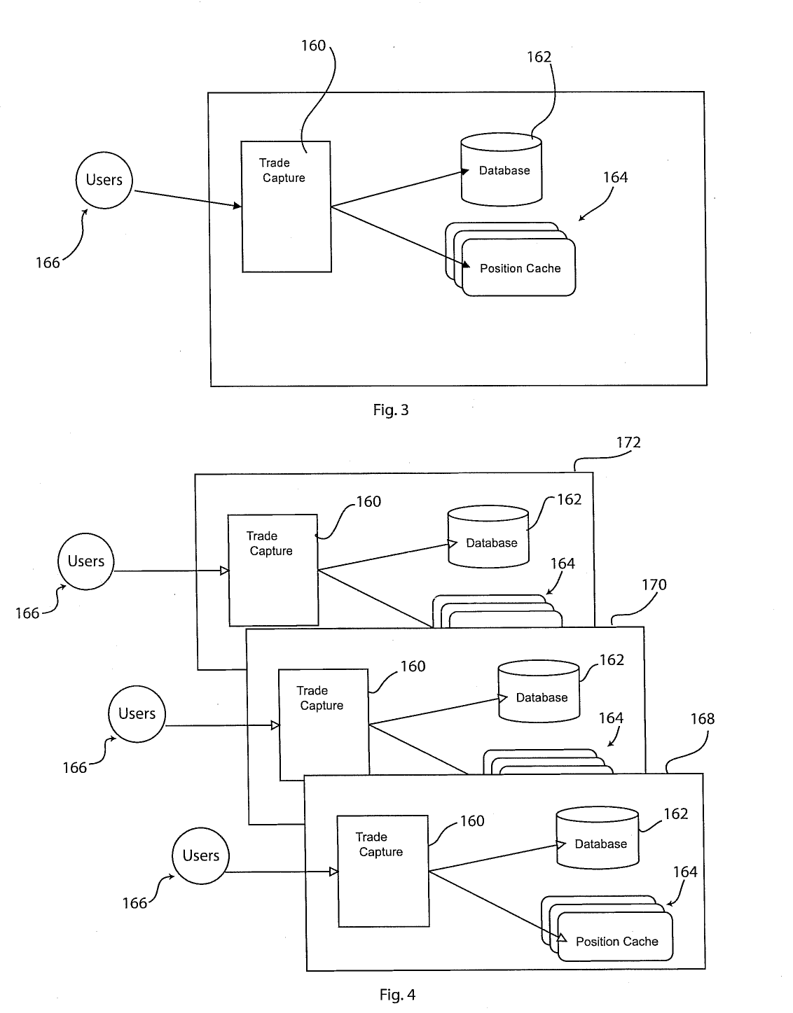

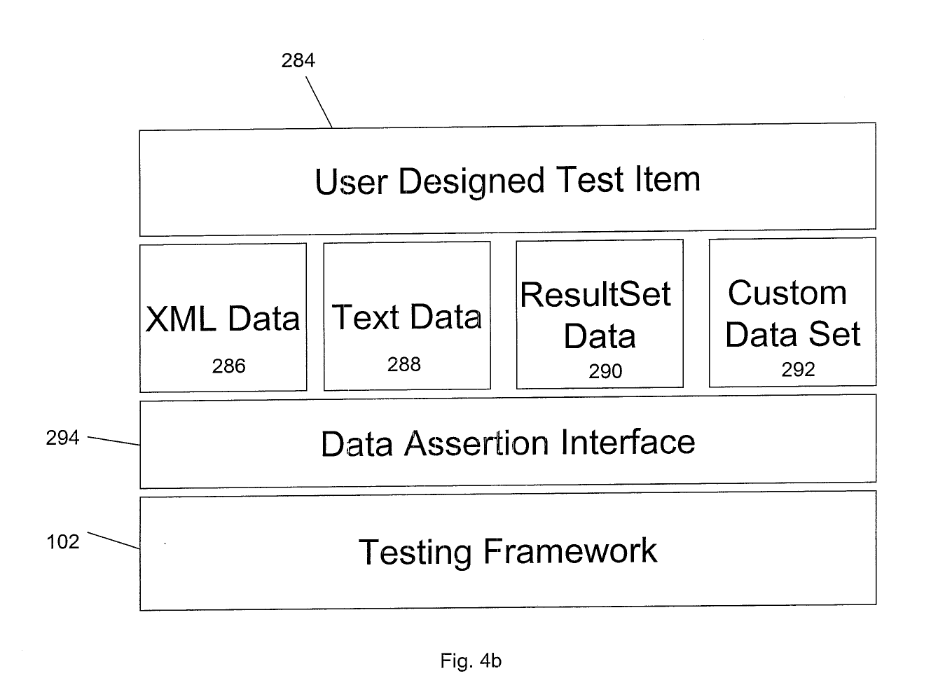

As mentioned above, testing system 100 may be uniquely customized to test any type of enterprise system. Moreover, testing system 100 may enable the user to create any number of specific and/or customized tests to test any type of problem an application may have. In one embodiment, testing system 100 facilitates testing enterprise system 104 as if it were a “black box.” This generally means that testing system 100 submits input data to enterprise system 104 and confirms that output data from the enterprise system 104 is equal to the expected output data. Testing system 100 may also monitor communications or message traffic sent between the different components of enterprise system 100, as described in more detail below. As a result, testing system 100 enables a tester to test for points of failure within enterprise system 104. In one embodiment, testing system 100 may test any number of points of failure in an enterprise system. For exemplary purposes, a non-limiting enterprise trading system 160 will used to describe the functionality of testing system 100 as shown in FIGS. 3 and 4.

In the non-limiting exemplary embodiment, enterprise trading system 160 may be coupled in communication to a database 162 and a cache server 164. A properly functioning enterprise trading system 160 enables a user 166 to submit a buy, sell or trade action of some quantity of items, at a price. In a properly functioning enterprise trading system 160 the trade is correctly captured by enterprise trading system 160 after user 166 submits the trade. Moreover, the quantity, price and recording of the transaction may be recorded in database 162. Then a properly functioning enterprise trading system 160 would send a message to various other cache servers 164 to reflect the trade transaction. As a result, in the non-limiting trading example, testing system 100 will test three points of failure of enterprise trading system 160: (1) whether the trade has been properly captured by enterprise trading system 160; (2) whether the database or the connection to the database is functioning such that the trade was properly recorded; and (3) whether the messaging layer is functioning.

In one embodiment, enterprise system 104 may have several different operating environments. Moreover, enterprise system 104 may have any number and any type of environments known to a person having ordinary skill in the art. To test enterprise system 104, a tester tests enterprise system 104 in each of the different environments, which may require a substantially amount of time to create individual tests for each different environment. As described in more detail below, testing system 100 enables the tester to create tests that are easily moveable between environments.

In the exemplary embodiment, enterprise trading system 160 may include a development environment 168, a quality assurance environment 170 and a production environment 172. In one embodiment, development environment 168 may be an application environment where a developer makes changes to the code and tests the changes made to enterprise trading system 160. Quality assurance environment 170 may be an application environment where a quality assurance tester may test and confirm and development changes before forwarding the changed version of the application to production. Production environment 172 may be an application environment that may be used by the intended end users of enterprise trading system 160. In the exemplary embodiment, the intended end users of enterprise trading system 160 may be traders.

Testing system 100 enables the user to create tests, wherein each test may be used in each of the different environments. As a result, testing system 100 facilitates reducing the amount of time required for the user to test enterprise system 104. Specifically, in the exemplary embodiment, as described in more detail below, each test may be associated with a different resource that may be associated with a different environment. As a result, testing system 100 enables each test to be transferrable between environments, as described in more detail below. Each resource may define parameters for the test such as, nut not limited to, hosts, ports, logins, handshake identifiers, keys and file and socket locations.

FIG. 4b illustrates an exemplary architecture of a test in relation to the data returned by the test which will be asserted or stored to be reused. The test may specify the incoming data type, or the test can specify a custom class which can convert the data into a data type that can be asserted by the framework 102. In this example, a user design test item 284 may utilize any of XML Data 286, Text Data 288, ResultSet Data 290, Custom Data Set 292 and/or any other desired data. This data may then be used for assertions through data assertion interface 294 and may be executed in a test through testing framework 102.

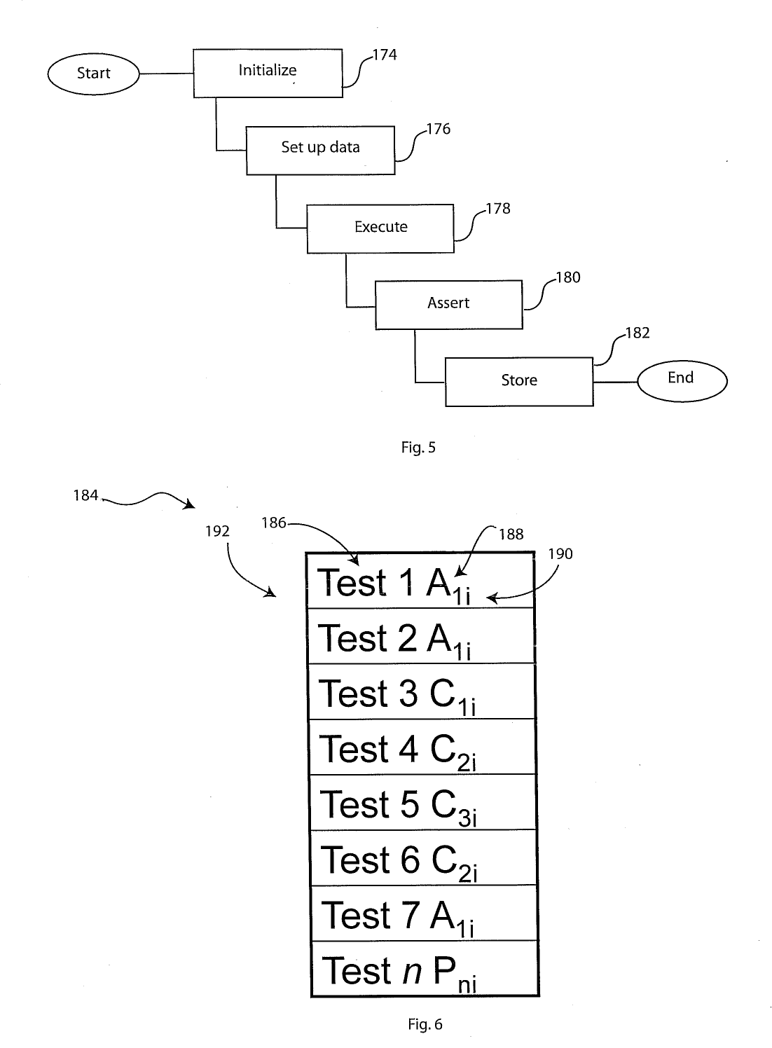

In the exemplary embodiment, a test may be a unit of work that testing system 100 executes to test the functionality and integrity of enterprise system 104. As shown in FIG. 5, in the exemplary embodiment, each test may perform some of the following five steps: (1) initialize 174; (2) set up data 176; (3) execute 178; (4) assert 180; and (5) store 182. Alternatively, each test may perform any number of steps known to a person having ordinary skill in the art that enables testing system 100 to function as described herein. Turning back to the exemplary embodiment, initialize step 174 may facilitate connecting a test to a specific resource. Set up data step 176 may generate and submit data to enterprise trading system 160. In one embodiment, set up step 176 may generate a number within a specific range and store the number as a variable. In another embodiment, set up step 176 may determine whether specific data values should be replaced with variables. Execute step 178 may facilitate sending the data to resource 107. Assert step 180 may facilitate determining whether the data sent to database 162 is the data that the user expects to be sent to database 162. Store step 182 facilitates storing any values that are returned from resource 107 as variables to be used by later tests.

In one embodiment, a test may generate response data from the system. Such response data may be stored or used to test other aspects of the system. System 100 enables the user to search the response data for specific data entries. The response data may be returned in different formats such as, but not limited to, text, spreadsheets, email and/or files. For example, in the event the response data is text based, system 100 may facilitate searching for the text data using a text based search function. Other search functions may include, but not limited to, XPATH expression for XML documents, map-based search function and user-defined classes that support a mapping function.

FIG. 6 illustrates a suite 184 of individual tests that may include test numbers 186, letters 188 and subtexts 190. In the exemplary embodiment, each letter 188 may represent a type of resource and each subtext 190 may represent a particular configuration of the resource and may include a particular identifier. Suite 184 may include of any number of tests, wherein one test may be dependent on a previous test. Each individual test may be an abstraction which may expose the same methods of testing but may allow for unlimited implementations in any system. Individual tests may include, but not limited to, database statements/connections, emitting/listening synchronous/asynchronous messages, socket connections, reading/writing files, reading/writing email and/or extendable to support system specific implementations of mock business functions.

Multiple tests may be created by the tester using testing system 100 and arranged in a particular order to form a test sequence 192. Each test may reference a particular resource, as indicated by letters 188. Moreover, each test may be slightly different to enable testing system 100 to test multiple aspects and/or points of failure of enterprise system 104. Testing framework 102 may execute test in a particular sequence to test enterprise system 104. In one embodiment, the tests can be executed to appear like an external system, or “mock” system, such that the user may test the interaction between enterprise system 104 and the mock system. In such an embodiment, testing system 100 generates test data that may have a signature that causes the data to appear as if it was generated by an external system.

As described below in more detail, each test may assert and store. In one embodiment, a test may be capable of any number of assertions and stores. In one embodiment, a store is a name/value pair that may be generated by the test, which can be used in a subsequent test for either driving or confirming data. Moreover, an assertion may be used to test a value produced in an individual test against a predetermined value, a calculated value, or a value stored in an earlier test. Assertions may be used to determine a point of failure of enterprise system 104. The tests may also have two types of parameters: the runtime parameters, which are relative to the use case in question such as query, input values, or values that a user/system would submit; and a second type of parameters that may relate to the protocol and settings which allow the test to connect to the environment in question. In one embodiment, the runtime parameters may be stored with the suite information but the second type of parameters would not be stored with the suite information. As a result, suite 184 may be moved between different environments. Moreover, the user may publish a test to a server which allows other users to execute the test and confirm the functionality of the enterprise system 104. Further, the tests may be run in groups, at pre-determined times and/or continuously.

In one embodiment, tests may be created for the production environment. In such an embodiment, tests may be configured to test a previously-executed action by the target enterprise system 104, which may include, but not limited to, writing data to a database, sending messages to users, sending orders to warehouses and/or outputting data. Such previously-executed actions may associate any one of the above-identified actions with a unique identification number, which may be used by a test to confirm whether the expected actions occurred. For example, in the non-limiting trading example, enterprise system 104 may execute a trade at the command of a user. Such a trade may typically cause subsequent actions to occur with other components of enterprise system 104. Such subsequent actions may include, but not limited to, recording the trade in a database, sending a trade order to a third party, sending a message to the user, recording the quantity and generating a unique Trade ID that may be associated with the trade. A test may be executed by testing framework 102 that uses the generated Trade ID to test whether the various subsequent actions were executed and whether such actions were executed correctly. As a result, testing framework 102 may test a production environment without the need of generating data and/or setting the enterprise system 104 into a desired state. Such tests provide a user with a status check of enterprise system 104.

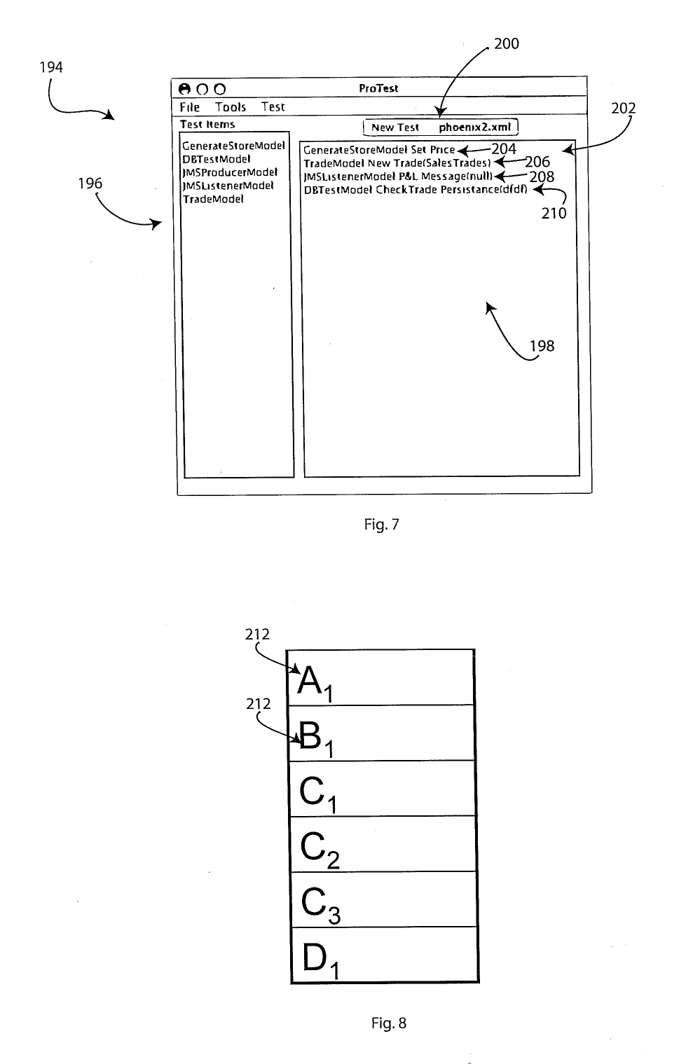

FIG. 7 is an illustration of a testing interface 194 that may be used to test enterprise system 104. In one embodiment, testing interface 194 may be a graphic user interface. In the exemplary embodiment, testing interface 194 may include a test items display area 196, a testing sequence display area 198 and a test sequence title 200. Test items display area 196 may display a list of available tests that have been created for a test sequence 202. Test sequence area 198 may display test sequence 202 of the individual tests that may be used by testing system 100 to test enterprise system 104. Test sequence title 200 may display the name of test sequence 202.

In the non-limiting trading example, test sequence 202 may include four tests, test one 204, test two 206, test three 208 and test four 210. Test one 204 may generate a new price to make the test trade uniquely identifiable. Test two 206 may facilitate submitting a trade to enterprise trading system 160 with the generated price from test one 204. Test three 208 may facilitate listening for a broadcast message of the trade by enterprise trading system 160. Finally, test four 210 may facilitate checking whether the trade has been persisted by enterprise trading system 160.

FIG. 8 illustrates a list of resources 212 that may have unique properties. In one embodiment, the user may use testing interface 194 to interface to facilitate testing enterprise system 104. Testing interface 194 enables the user to define a resource relative to an environment to a test, as shown in FIG. 8. Each resource may specify a property that the test type may share. Testing interface 194 may also enable the user to create a test sequence of individual tests that may be arranged in a particular order, wherein the tests are executed in the listed order when the testing sequence is initiated. As a result, the user may create tests, test sequences and execute tests using testing interface 194 to enable the user to test enterprise system 104. In the non-limiting trading example, A₁ may define a resource as http://myserver:8080/. Moreover, C₁ may be defined as jms/topic/topic1/user1/password, C₂ may be defined as jms/topic/topic2/user1/password and C₃ may be defined as jms/queue/qname/user3/password.

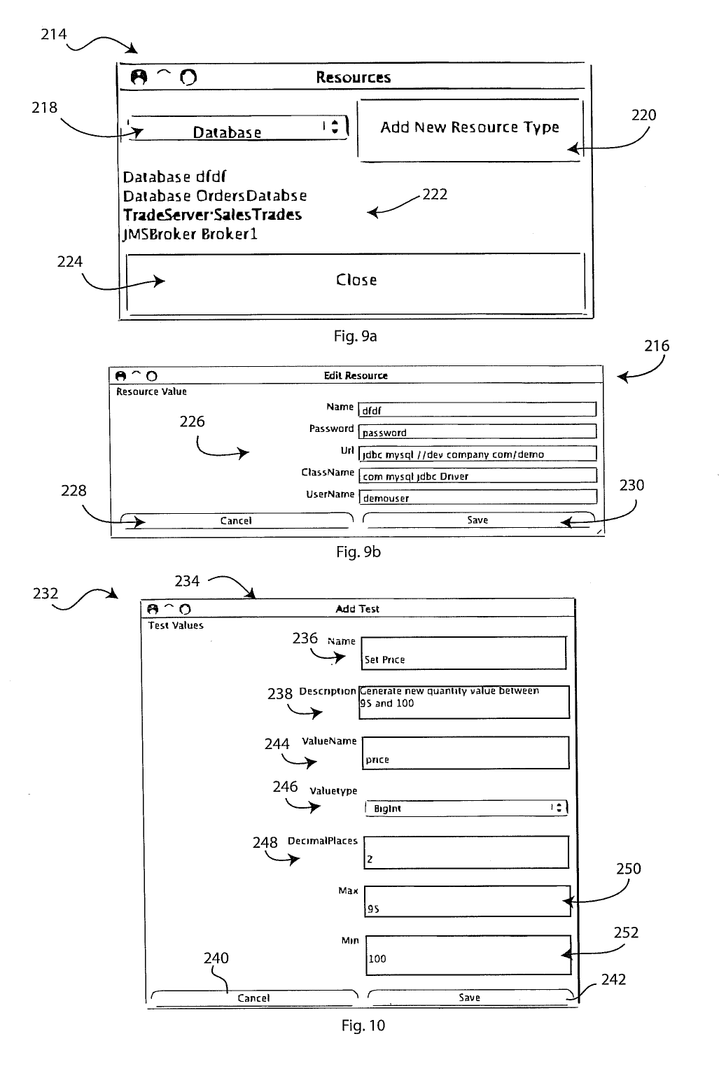

FIG. 9a is an illustration of a resource window 214 that may be used with testing system 100. FIG. 9b is an illustration of an edit resource window 216. Specifically, a user may use resource window 214 to add and/or edit resources that may be used in the tests. In one embodiment, resource window 214 may include a resource type pull-down box 218, an add new resource button 220, a resource display area 222 and a close button 224. Resource type pull-down box 218 may include a variety of different types of resources that may be associated with the test. Display area 222 facilitates listing the resources that may be available for the tests. In the event no resources are listed in display area 222, the user may click on add new resource type button 220 to add a new resource. In the non-limiting trading example, resource type pull-down box 218 may include, but not limited to, a database resource, a trade server resource and a broker resource. Alternatively, testing system 100 may use any type of resources that are relevant to testing enterprise system 104.

Once the user clicks on add new resource button 220, edit resource window 216 may open, as shown in FIG. 9b. Alternatively, edit resource window 216 may open in the event the user clicks on one of the selected resources displayed in display area 222. Edit resource window 216 may include resource information boxes 226, which may include, but not limited to, a name box, a password box, a uniform resource locator (URL) box, a class name box and a username box. Edit resource window 216 may also include a cancel button 228 and a save button 230.

During operation, the user may add a resource to testing interface 194 using resource window 214. In the non-limiting trading application example, the user may add a new database resource type by setting a database from resource type pull-down box 218 and then clicking add new resource type button 220. Edit resource window 216 may then open and the user may enter the database name, the database password, the database URL, the database class name and the database username. Once the information has been entered, the user may click on save button 230 to save the changes. Once the user has added and/or edited all the desired databases, the user may close resource window 214.

FIG. 10 is an illustration of an add test window 232 that the user may use to add and/or edit the tests. Moreover, add test window 232 may include a test name box 236, a test description box 238, a cancel button 240 and a save button 242. As described above, any number of tests may be created and used during the testing of the underlying application. Moreover, each test may be unique. In the non-limiting trading example, a GenerateStore test 234 may be uniquely designed to generate data to be used in a test, execute the test and store the data. In such an example, GenerateStore test 234 may include a value name box 244, a value type selector box 246, a decimal places box 248, a maximum box 250 and a minimum box 252. Such boxes may be unique just to GenerateStore test 234. Value name box 244 may include a name of the value generated, such as but not limited to “price.” Value type selector box 246 enables the user to select the type of value. In the exemplary non-limiting trading embodiment, the value type is “BigInt.” Alternatively, the value type may be currency, a date, hexadecimal, binary or any other type of number known to a person having ordinary skill in the art. Decimal place box 248 may be 2, maximum box 250 may be 95 and minimum box 252 may be 100. As such, GenerateStore test 234 may generate a number from 95 to 100 by 2 decimal places and store the value mapped to a variable called “price.”

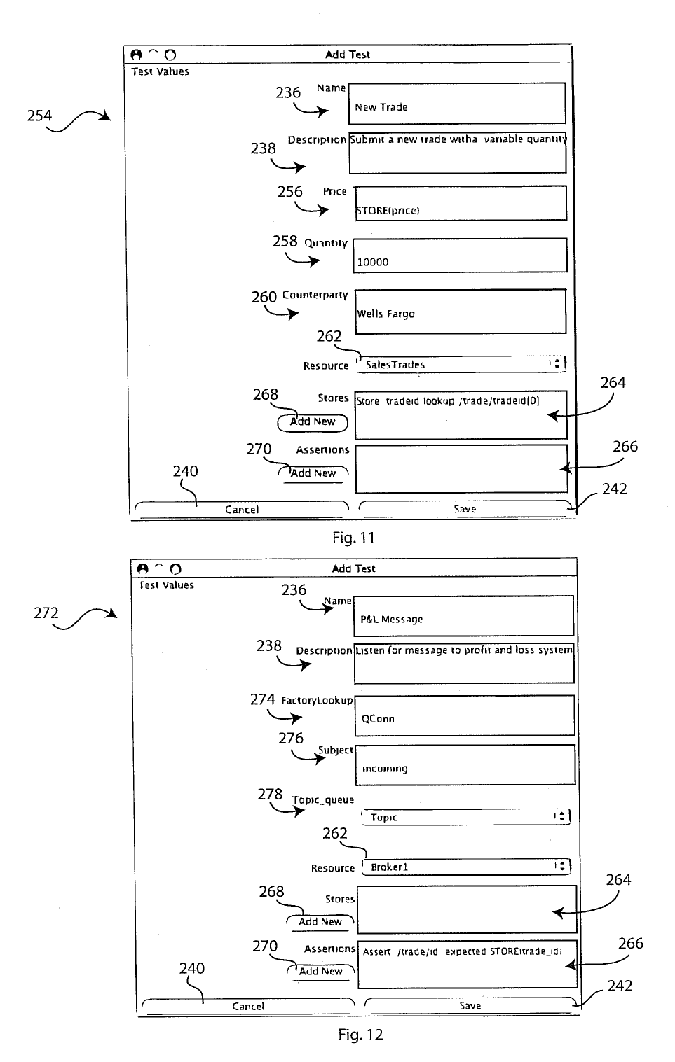

FIG. 11 is an illustration of a trade test 254 that may be custom-made specifically for the non-limiting trading example. Moreover, trade test 254 may be created using add test window 232. Similar to GenerateStore test 234, as described above, trade test 254 may include test name box 236, test description box 238, cancel button 240 and save button 242. In the exemplary embodiment, trade test 254 may be may be uniquely designed for enterprise trading system 160 to submit data, or trades, which may be set in a manner specifically for enterprise trading system 160 such that enterprise trading system 160 would generate a trade identifier, or trade ID, as described below. In such an embodiment, trade test 254 may include a price box 256, a quantity box 258 a counter party box 260, a resource selector box 262, a stores box 264 and an assertions box 266.

In the exemplary embodiment, price box 256 may be a variable, such as but not limited to, STORE(price). In such an embodiment, STORE(price) enables testing system 100 to assign a variable value to the price which may be substantially equal to the price value set in GenerateStore test 234. Quantity box 258 may be set to a fixed number. Alternatively, quantity box 258 may be a variable number. In the exemplary embodiment, stores box 264 may be set to “Store: tradeid lookup:/trade/tradeid[0],” which in this example is an XPATH language expression, but the store/assert field can also be name/value pair, text search, or the custom class which can convert the data into a data type that can be asserted by the framework. Alternatively, stores box 264 may be populated with test search language to for searching files, map language for name-value pairs and custom language for custom user-designed tests. Trade test 254 also includes an add new store button 268 and an add new assertion button 270 to facilitate adding new stores and assertions respectively.

FIG. 12 is an illustration of a Java Message Service (“JMS”) Listen test 272 that may be custom-made specifically for the non-limiting trading example to test enterprise trading system 160. Moreover, JMS Listen test 272 may be created using add test window 232. In the non-limiting example, JMS Listen test 272 may be configured to listen on a particular topic for particular messages being sent within enterprise trading system 160, which may trigger application functionality. In one embodiment, testing framework 102 may receive these messages and convert them to a format that enables the user to change values based on stored values or hardcode values into a new message for the test. As a result, when the test is run, a message identical to the original message may be generated and may include some customized values. This message can be generated repeatedly to force the system into a desired state without the requirement of the portion of the system that would normally facilitate generating the message.

In one embodiment, the user may want to force the system into a desired state where the state may trigger a pre-programmed event. For example, in one example, the system may monitor bank accounts of users where the system is programmed to notify a user when their account balance is less than zero. To test the system's functionality, the system must be put into a specific state to trigger the system's pre-programmed events. In one example, the system may be programmed to email the user if the account balance is two hundred dollars overdrawn. Moreover the system may be programmed to notify the management if the account is five hundred dollars overdrawn. To test this functionality of the system, the user may generate data or information that may be sent to the system to set the desired state. In one embodiment, for example, the user may wish to send messages or information to the system to set the state of the system such that a user's account is overdrawn by two hundred dollars. As a result, the tester will ensure that the system generates a balance warning email to the user.

Similar to the tests described above, in the exemplary embodiment, JMS Listen test 272 may include test name box 236, test description box 238, cancel button 240 and save button 242. Moreover, JMS Listen test 272 may include a factory lookup box 274, a subject box 276, a topic queue selector box 278, resource selector box 262, stores box 264 and assertions box 266. JMS Listen test 272 also includes add new store button 268 and add new assertion button 270 to facilitate adding new stores and assertions respectively.

In the non-limiting trading example, factory lookup box 274 may indicate a Java Naming Directory Interface (“JNDI”) lookup for the connection object. Subject box 276 may indicate what type of message JMS Listen test 272 is listening for. In the exemplary embodiment, JMS Listen test 272 is set to listen for an incoming message, which is sent from enterprise trading system 160 to the resource. Topic queue selector box 278 enables the user to select a particular topic queue from a plurality of options. In the exemplary embodiment, the topic queue is set to “Topic.” Alternatively, the topic queue may be set to any other topic queue known to a person having ordinary skill in the art that enables testing system 100 to function as described herein. Resource selector box 262 enables the user to select a particular resource associated with the test. In the exemplary embodiment, the resource is set to “Broker1.” In the exemplary embodiment, store box 264 may be empty. In one embodiment, store box 264 may include a store command that instructs the test to store values in the message such as position or quantity. In the exemplary embodiment, assertions box 266 may be set to “Assert: /trade/id expected: STORE(trade_id),” as described in more detail below.

In the exemplary embodiment, JMS Listen test 272 may be may be uniquely designed for enterprise trading system 160 to listen on a topic, assert an expected result and report a positive result in the event JMS Listen test 272 hears a message where all the assertions are true. Otherwise, JMS Listen test 272 may return a failure after a predetermined time has expired and no message meeting all the assertions has been heard.

During operation, JMS Listen test 272 may initialize and connect to the topic and begin listening for messages. Next, JMS Listen test 272 may assert, as each message comes in, JMS Listen test 272 may check via “XPATH” and/or any other parameter, to determine if the message has a particular trade ID.

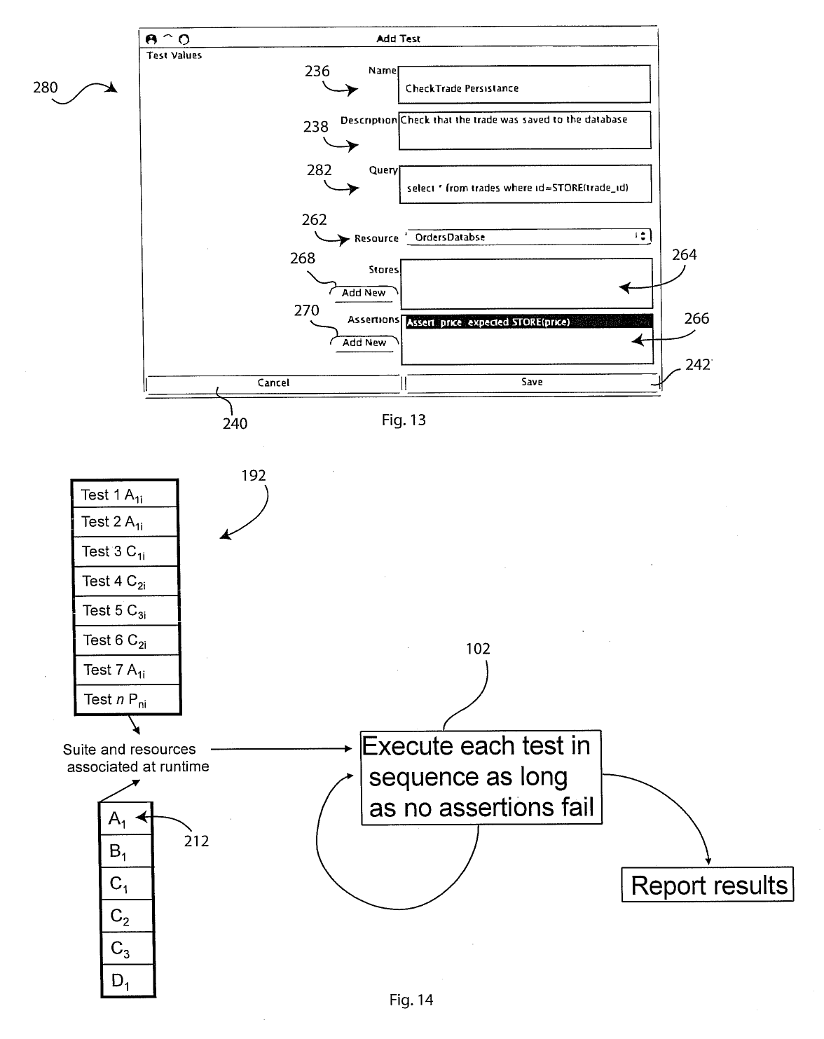

FIG. 13 is an illustration of a database check test 280 that may be custom-made specifically for the non-limiting trading example to test enterprise trading system 160. Moreover, database check test 280 may be created using add test window 232. In the non-limiting example, database check test 280 may be configured to check that enterprise trading system 160 has properly written a file to the database. Similar to the tests described above, database check test 280 may include test name box 236, test description box 238, cancel button 240 and save button 242. Moreover, database check test 280 may include a query box 282, resource selector box 262, stores box 264 and assertions box 266. Database check test 280 also includes add new store button 268 and add new store button 270 to facilitate adding new stores and assertions respectively.

In the non-limiting trading example, query box 282 instructs database check test 280 to check a specific data entry. In the exemplary embodiment, query box 282 may contain “select * from trades where id=STORE(trade_id).” Resource selector box 262 enables the user to select a particular resource associated with the test. In the exemplary embodiment, the resource is set to “OrdersDatabase,” store box 264 may be empty and assertions box 266 may be set to “Assert: price expected:STORE(price),” as described in more detail below. Alternatively, store box 264 may include a store command that instructs the test to store values in database 162. As a result, database check test 280 may be may be uniquely designed for enterprise trading system 160 to query database 162 using the query found within query box 282 and assert that the price is saved as the same price that was submitted to enterprise trading system 160.

During operation, database check test 280 may initialize and connect to database 162. Next, database check test 280 may prepare the query, replace the STORE(trade_id) with the variable stored in the earlier tests. Database check test 280 may then issue the query to database 162 and retrieve, or fetch, the results. The test may then assert, or check that the price found within the database matches the price that was entered previously.

Once the suite of tests have been created and the resources have been added to testing framework 102, the suite of tests may be associated with the resources for a particular environment, as shown in FIG. 14. Each test may be executed in sequence, so long as no assertion fails. Once the test sequence is complete, once the test is complete the test can be published from the GUI to a server where the test can be run against any of the environments that are configured on the server. [0066] The GUI will also have the ability to load and update test on the server. From the server the tests can be managed with a source control system.

During operation of the non-limiting trading application example, test sequence 192 may be run. Specifically, GenerateStore test 234 may execute and generate a number of 97.26. The GenerateStore test 234 may then store that value as “price.” Next, in setting up the values, trade test 254 may determine that the price needs to be retrieved and may replace that value with 97.26. Trade test 254 may then send a complete trade message to enterprise trading system 160 and may get a response with a trade_id. This ID may be stored as “trade_id.” Testing framework 102 may then execute JMS Listen test 272, which may listen for messages to the cache system in a particular format. In one embodiment, the format may be XML. When JMS Listen test 272 receives a trade that references the trade in question, JMS Listen test 272 may return a positive result. Database check test 280 may replace the STORE(trade_id) with the actual value for the trade. Database check test 280 may also replace the STORE(price) assertion with the real value. Database check test 280 may then issue the query and receive a result set. The database check test 280 may then determine whether the price recorded in database 162 is equal to 97.26. If there is a match, testing framework 102 returns a success to the user.

In the event there is a failure, testing framework 102 may return a failure indication back to the tester. In the non-limiting trading application example, testing framework 102 may find a failure in the trade capture by enterprise trading system 160. In one embodiment, testing framework 102 may determine that the trade capture function is not working properly. Moreover, testing framework 102 may determine using JMS Listen test 272 that the messaging layer is not functioning or that the trade capture system is not propagating a message. Last, testing framework 102 may determine that database 162 is down or that trade capture system is not persisting the trades to database 162.

In the exemplary embodiment, GenerateStore test 234, trade test 254, JMS Listen test 272 and database check test 280 may be associated with resources in development environment 168. Alternatively, GenerateStore test 234, trade test 254, JMS Listen test 272 and database check test 280 may be associated with resources in either quality assurance environment 170 or production environment 172. The user may re-associate each test to a different resource in a different environment. As a result, the user does not need to recreate tests for different environments. As a result, testing system 100 facilitates reducing the time required to test the different environments of enterprise system 104.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A computer storage medium having a computer-readable code segment for performing a method comprising:
receiving inputs from a user using an interface, the inputs define a test that is run against the application software;
associating a resource with the test, the resource selected by the user using the interface;
executing the test against the application software;
comparing an outputted value of the application software with an expected value; and
outputting a result.

2. The computer storage medium of claim 1, having a computer-executable code segments for performing a method further comprising:
receiving inputs from a user using an interface, wherein the interface includes a graphical user interface.

3. The computer storage medium of claim 1, wherein executing the test against the application software further comprising:
generating data using the test; and
sending the generated data to the application software such that the enterprise system is set into a desired state and/or produces an outputted value.

4. The computer storage medium of claim 3, having a computer-executable code segments for performing a method further comprising:
asserting the generated data against the application software;
comparing the generated data with the outputted value; and
reporting at least one of a positive result when the generated data is substantially equal to the outputted value and a negative result when the generated data is not substantially equal to the outputted value.

5. The computer storage medium of claim 1 having a computer-executable code segments for performing a method further comprising associating a resource of a first environment with the test at runtime.

6. The computer storage medium of claim 5 having a computer-executable code segments for performing a method further comprising associating a resource of a second environment of the target system with the test, wherein the second environment is substantially different than the first environment.

7. The computer storage medium of claim 1, wherein executing the test further comprises storing a data name/value pair to be used in a subsequent test.

8. The computer storage medium of claim 2, having a computer-executable code segments for performing a method further comprising:
searching response data generated by the test using at least one of an XPATH expression for XML documents, a text based search function, a map based search function and/or a user defined class which supports a mapping function.

9. The computer storage medium of claim 1 having a computer-executable code segments for performing a method further comprising:
listening for messages sent by the application software, the messages include message data therein;
comparing the message data with at least one of a predetermined value, a calculated value and a stored value; and
reporting a positive report when the message data is substantially equal to at least one of the predetermined value, the calculated value and the stored value.

10. The computer storage medium of claim 1 having a computer-executable code segments for performing a method further comprising:
reporting at least one of a positive result when the outputted value is substantially equal to the expected value and a negative result when the outputted value is not substantially equal to the expected value; and
recording a history of the reported results.

11. The computer storage medium of claim 1 having a computer-executable code segments for performing a method further comprising:
storing data values returned from a resource as variables; and
reporting stored data to the user.

12. A system for testing application software, comprising:
a processor;
a testing framework executed by the processor;
an application software coupled to the testing framework;
a test builder coupled to the testing framework, the test builder receives inputs from a user to build a test;
a resource coupled to the testing framework and associated with the test; and
a message object coupled to the testing framework and executed by the processor to generate and send messages to the application software.

13. The system of claim 12, wherein the framework comprises a plurality of interfaces that enable a user to define new tests and resources that interact with the framework.

14. The system of claim 13, wherein the plurality of interfaces enables the user to publish a test to a server which allows other users to execute the test and confirm the functionality.

15. The system of claim 12, wherein the testing framework is configured to run in at least one of a group and at a pre-determined time.

16. The system of claim 12, wherein a resource defines parameters that comprises at least one of a host, a port, a login, a handshake identifier, a key and a file and socket location.

17. The system of claim 12, wherein the testing framework comprises:
a name;
a description; and
at least one of a resource, an assertion and a store.

18. The system of claim 12 further comprising an output device for outputting a test result to a user.
